(19) United States
(12) Patent Application Publication
(10) Pub. No.: US 2014/0129758 A1
(43) Pub. Date: May 8, 2014

(54) WEAR LEVELING IN FLASH MEMORY DEVICES WITH TRIM COMMANDS

(71) Applicant: SPANSION LLC, Sunnyvale, CA (US)

(72) Inventors: Shinsuke Okada, Kanagawa (JP); Yuichi Ise, Kanagawa (JP); Daisuke Nakata, Kanagawa (JP)

(73) Assignee: SPANSION LLC, Sunnyvale, CA (US)

(21) Appl. No.: 13/669,633

(22) Filed: Nov. 6, 2012

(51) Int. Cl. G06F 12/00

(52) U.S. Cl. 711/103; 711/E12.008

(57) ABSTRACT

Systems and methods are provided to implement a memory device that includes a memory array having a plurality of sectors, a non-volatile memory that stores sector state information, and a memory controller that performs wear leveling according to the sector state information. The sector state information can specify respective states for respective sectors of the plurality of sectors of the memory array. The memory controller, based on the states of respective sectors, determines whether or not to swap contents of the sectors during wear leveling, thereby reducing write amplification effects.

### TECHNICAL FIELD

The subject disclosure relates to a wear leveling in flash memory devices, and in particular, utilizing TRIM commands to enhance wear leveling to reduce write amplification and to increase power failure tolerance during wear leveling processes.

### BACKGROUND

A wide variety of memory devices can be used to maintain and store data and instructions for various computers and similar systems. In particular, FLASH memory is a type of electronic memory media that can be rewritten and that can retain content without consumption of power. Unlike dynamic random access memory (DRAM) devices and static random memory (SRAM) devices in which a single byte can be altered, FLASH memory devices are typically erased in fixed multi-bit blocks or sectors. FLASH memory technology can include NOR FLASH memory and/or NAND FLASH memory, for example. FLASH memory devices typically are less expensive and denser as compared to many other memory devices, meaning that FLASH memory devices can store more data per unit area.

FLASH memory has become popular, at least in part, because it combines the advantages of the high density and low cost of erasable programmable read-only memory (EPROM) with the electrical erasability of EEPROM. FLASH memory is nonvolatile; it can be rewritten and can hold its content without power. It can be used in many portable electronic products, such as cell phones, portable computers, voice recorders, thumbnail drives and the like, as well as in many larger electronic systems, such as cars, planes, industrial control systems, etc. The fact that FLASH memory can be rewritten, as well as its retention of data without a power source, small size, and light weight, have all combined to make FLASH memory devices useful and popular means for transporting and maintaining data.

In addition, the popularity and performance of FLASH memory devices has lead to solid state drives (SSDs) replacing traditional block drives (e.g., magnetic disk drives) in many computing systems. SSDs often provide superior write and read performance compared with electromechanical counterparts. However, SSDs, being FLASH-based, can be susceptible to degraded write performance in some scenarios. For instance, FLASH memory can be programmed in small chunks, often referred to as pages, but is erased in larger chunks or groups of pages referred to as blocks or sectors. Moreover, with typically FLASH memory, data cannot be directly overwritten. A cell is first erased before new data can be programmed. Accordingly, when overwriting data store on an SSD, from the host system or file system perspective, the old data is replaced on the disk with new data. However, from the SSD perspective, the new data is written to a free portion, while the old data remains on the disk but is marked invalid. When a free portion is unavailable, the SSD performs a more involved process of multiple internal programming and erase operations to complete the overwrite operation. This leads to a phenomenon known as write amplification, where the number of bytes actually written by the SSD is greater, by some factor, than the number of bytes provided to the SSD by a host system. High write amplification can reduce drive performance.

In addition to situations with an SSD at near fully capacity, other factors can contribute to write amplification. For instance, wear leveling operations of the SSD can increase write amplification. FLASH memory, as mentioned above, is erased before it is programmed and the memory has a limited lifetime in terms of program/erase cycles. When just one block of a FLASH memory exceeds its lifetime and becomes degraded, the entire FLASH memory device is often rendered unusable. Accordingly, wear leveling operations shift information among blocks to distribute erasures and re-writes around the medium and avoid particular blocks from becoming excessively worn. However, as wear leveling increases write amplification, it can impact throughput as well as a service life of FLASH memory.

The above-described deficiencies of conventional FLASH memory and wear leveling mechanisms are merely intended to provide an overview of some of the problems of conventional systems and techniques, and are not intended to be exhaustive. Other problems with conventional systems and techniques, and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various, non-limiting embodiments, a memory device is provided that includes a memory array having a plurality of sectors, a non-volatile memory that stores sector state information, and a memory controller that performs wear leveling according to the sector state information. The sector state information can specify respective states for respective sectors of the plurality of sectors of the memory array. The memory controller, based on the states of respective sectors, determines whether or not to swap contents of the sectors during wear leveling, thereby reducing write amplification effects.

These and other embodiments are described in more detail below.

### BRIEF DESCRIPTION OF THE DRAWINGS

Various non-limiting embodiments are further described with reference to the accompanying drawings in which:

FIG. 1 is a flow diagram illustrating an exemplary, non-limiting embodiment for performing wear leveling in accordance with state information for respective sectors of a memory;

FIG. 2 is a block diagram illustrating an exemplary, non-limiting memory device configured to perform wear leveling based on state information maintained for respective sectors of a flash memory array;

FIG. 3 illustrates a flow diagram of an exemplary, non-limiting embodiment for programming data to a memory device;

FIG. 4 illustrates a block diagram of an exemplary, non-limiting act of programming data to a memory device;

FIG. 5 is a flow diagram of an exemplary, non-limiting embodiment for overwriting data on a memory device;

FIG. 6 is a block diagram of an exemplary, non-limiting act of overwriting data on a memory device;

FIG. 7 is a flow diagram illustrating an exemplary, non-limiting embodiment for performing a conventional wear leveling operation;

FIG. 8 is a flow diagram illustrating an exemplary, non-limiting embodiment for performing a wear leveling operation in view of state information on sectors;

FIG. 9 illustrates a flow diagram of an exemplary, non-limiting embodiment for modifying state information based on a TRIM command;

FIG. 10 illustrates a flow diagram of an exemplary, non-limiting embodiment for accessing state information via a TRIM command;

FIG. 11 illustrates a flow diagram of an exemplary, non-limiting embodiment for internally updating state information in accordance with an erase operation;

FIG. 12 is a flow diagram of an exemplary, non-limiting embodiment for internally updating state information in accordance with an programming operation;

FIG. 13 illustrates a state diagram of sector state information in accordance with one or more aspects of the subject disclosure;

FIG. 14 illustrates a block diagram of an exemplary, non-limiting memory device in accordance with one or more aspects of the subject disclosure; and

FIG. 15 is a block diagram of an exemplary, non-limiting host system that includes a memory device according to one or more aspects disclosed herein.

### DETAILED DESCRIPTION

### General Overview

As discussed in the background, conventional flash memory devices utilize wear leveling to distribute program/erase cycles across blocks of a flash array to avoid individual block from becoming excessively worn relative to other blocks of the flash array. According to an example, a flash memory device tracks a number of program/erase cycles for each sector of a flash array. When the number of program/erase cycles, for a given sector, reaches a certain value, then the sector is swapped with a minimally cycled sector (e.g., the sector having the lowest number of program/erase cycles).

However, as mentioned above, wear leveling increases write amplification as compared to write amplification of memory devices without wear leveling implementations. Write amplification, in an aspect, refers to a quantity defined as a number of bytes programmed to a flash memory array divided by a number of user requested bytes provided to a flash memory controller. When data can be programmed directly without wear leveling, or overwrite procedures, write amplification equals one. However, when overwrite procedures and/or wear leveling are performed, write amplification is typically greater than one. This is due, in part, to swapping a sector with the minimally cycled sector, which results in additional bytes being programmed to the flash memory array.

In various, non-limiting embodiments a memory device is provided that maintains states for respective sectors of a memory array and performs wear leveling in view of the states. For instance, a state of a sector indicates that the sector is free (e.g., in an erased state with no data programmed), stale (e.g., in a programmed state but with old data no longer relevant to a host system), or valid (e.g., in a programmed state with data relevant to the host system). To reduce write amplification, the memory device forgoes swapping with the minimally cycled sector when the minimally cycled sector does not include valid data (e.g., the state of the minimally cycled sector is either free or stale). However, while swapping may not occur when the state of the minimally cycled sector is stale, the memory device can erase the minimally cycled sector during wear leveling (e.g., restore to an erased or free state) to make the minimally cycled sector available for future write operations.

In one embodiment, a memory device is described herein that includes a memory array including a plurality of memory sectors, a non-volatile memory configured to retain sector state information, wherein the sector state information that specifies respective usage states for respective sectors of the plurality of memory sectors, and a memory controller configured to perform a wear leveling operation on two or more sectors of the plurality of memory sectors, the memory array, wherein the wear leveling operation is executed in accordance with respective states of the two or more sectors. In an example, the non-volatile memory is further configured to retain sector cycle information that specifies respective numbers of program/erase cycles performed on respective sectors of the plurality of sectors and the memory controller is further configured to determine when to initiate the wear leveling operation on the two or more sectors based on respective numbers of program/erase cycles respectively associated with the two or more sectors. For instance, the memory controller is configured to select at least one of the two or more sectors based on the sector cycle information, wherein the at least one of the two or more sectors is a minimally cycled sector as indicated in the sector cycle information.

In another example, the memory controller is further configured to execute the wear leveling operation in response to an erase operation on the memory array. To perform the wear leveling operation, the memory controller is configured to erase a first sector of the two or more sectors, identify a state associated with a second sector of the two or more sectors, determine whether to copy contents of the second sector to the first sector based on the state identified, and determine whether to erase the second sector based on the state identified. In an example, the memory controller is configured to copy the contents of the second sector to the first sector when the state identified is a valid data state and to update an address mapping such that an address mapped to the second sector becomes mapped to the first sector. In addition, the memory controller is configured to erase the second sector when the state identified is one of an invalid data state or a valid data state. Moreover, the memory controller is configured to update the sector state information in response to embedded operations performed by the memory controller on the memory array or to update the sector state information in response to a command received from a host system of the memory device.

According to additional examples, the non-volatile memory is a reserved sector of the plurality of sectors, the usage states included in the sector state information include a free state, a valid data state, and an invalid data state, and the memory array is a flash memory array.

According to further embodiments, a method is described herein that includes receiving a command to erase a first sector of a plurality of sectors of a memory array, determining a usage state, corresponding the second sector, specified by sector state information, erasing the first sector, copying contents of the second sector to the first sector when the usage state of the second sector indicates that the second sector include valid data, and erasing the second sector when the usage state of the second sector indicates that the second sector includes one of valid data or invalid data. In addition, the method can include updating the sector state information to indicate the usage state of the second sector is an erased state.

In an additional embodiment, a computing device is described herein that includes a memory device having a memory controller, a memory array including a plurality of blocks, and a non-volatile memory configured to retain sector state information. The computing device can further include a computer-readable storage medium having stored thereon a driver configured to provide storage services to at least one of an operating system or a file system of the computing device and to interface with a memory device embedded with the computing device to implement storage operations in response to requests issued from the at least one of the operating system or the file system. According to an example where an erase operation, generated from at least one of the memory controller or the driver, is received relative to a first block of the memory array, the memory controller is configured to initiate a wear leveling operation on the first block and a second block of the memory array accordance with a state of the second block as specified by the sector state information. According to another example, the driver is further configured to transmit a command to memory device when the at least one of the operating system or the file system requests deletion of a file, wherein the command indicates blocks of the memory array associated with the file, and the memory controller is further configured to update states, in the sector state information, associated with the blocks indicated in the command.

Herein, an overview of some of the embodiments for a memory device that performs wear leveling in accordance with sector states has been presented above. What follows next is an overview of exemplary, non-limiting embodiments for and features of a memory device are described in more detail.

### Sector State Management and Wear Leveling

As mentioned above, in various embodiments, a memory device can manage sector states for respective sectors of a memory array and utilize the sector states to reduce a write amplification increase during wear leveling. By reducing write amplification during wear leveling, the memory device extends the service life of the memory array, while improving throughput. In addition, by maintaining sector states, the memory device increases tolerance to power failures during wear leveling.

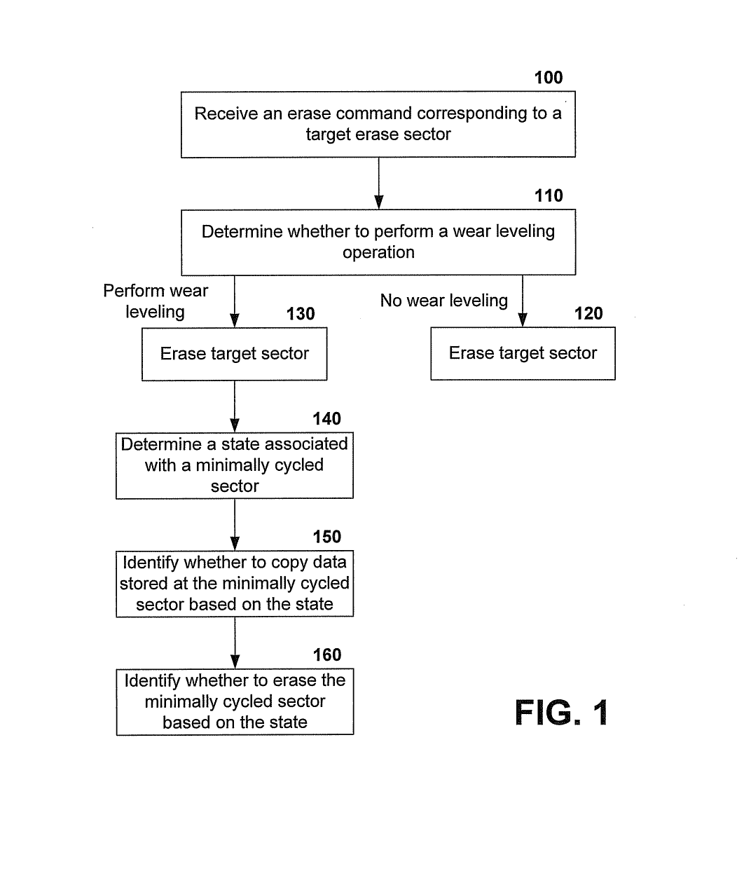

With respect to one or more non-limiting aspects of the memory device as described above, FIG. 1 shows a flow diagram illustrating an exemplary, non-limiting embodiment for performing wear leveling in accordance with state information for respective sectors of a memory. The embodiment depicted in FIG. 1 can be employed by a memory device that includes a memory controller and a memory array (such as a flash memory array) as described below in accordance with one or more embodiments. As shown in FIG. 1, at 100, an erase command, corresponding to a target erase sector of a memory, is received. As an example, the erase command can be an explicit erase command, e.g., originating from a host system, or an implicit erase command, e.g., generated internally as part of garbage collecting or an overwrite procedure. At 110, it is determined whether or not to perform wear leveling operation in connection with the received erase command. According to an example, respective numbers of program/erase cycles performed on respective sectors of the memory can be recorded. A wear leveling operation can be executed when the number of program/erase cycles of the target erase sector exceeds a threshold. The threshold, in an example, can be a specified as a distance from a mean number of program/erase cycles across all sectors of the memory (e.g., one standard deviation above, above a particular percentile, etc.). Accordingly, the threshold evolves as the memory ages. In another example, the threshold can be based upon a difference value, e.g., between the target erase cycle and a minimally cycled sector, such that wear leveling is performed when the difference value exceeds the threshold. According to this example, the threshold can represent a tolerable limit to a distribution of wear among sectors of the memory (e.g., tolerable deviation between a maximum wear amount and a minimum wear amount).

At 120, when no wear leveling occurs, the target sector is erased. At 130, the target sector is also erased. However, the erasure at 130 commences a wear leveling operation. After erasing the target sector, at 130, a state associated with a minimally cycled sector is determined at 140. At 150, it is identified whether to copy data stored at the minimally cycled sector based on the state of the minimally cycled sector. For instance, when the state of the minimally cycled sector indicates that the sector includes stale or no data, then the minimally cycled sector is not copied. At 160, it is identified whether to erase the minimally cycled sector based on the state. For example, when the state indicates the minimally cycled sector contains no data, an erase is not performed. Thus, an unnecessary erase cycle is not imposed on the minimally cycled sector.

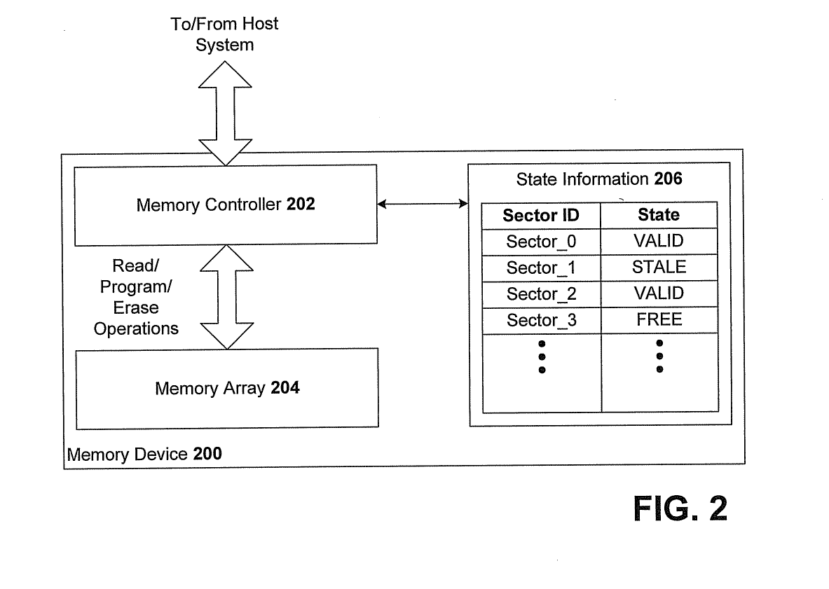

FIG. 2 is a block diagram illustrating an exemplary, non-limiting memory device configured to perform wear leveling based on state information maintained for respective sectors of a memory array. As shown in FIG. 2, a memory device 200 can include a memory controller 202 configured to interface with a host system (not shown) via, for example, a system bus. As described in more detail below, the memory controller 202 communicates with a driver of the host system. Based on communications (e.g., commands) from the host system, memory controller 202 interacts with a memory array 204. Memory array 204 can include a plurality of memory cells arranged in columns and rows. At a higher level of abstraction, memory array 204 is arranged into a plurality of pages, with respective sets of pages additional grouped into blocks or sectors. According to one example, memory array 204 can be a flash memory array; however, it is to be appreciated that memory array 204 can be substantially any type of memory which benefits from wear leveling procedures.

Memory controller 202 is configured to interface with memory array 204 via read, program, and/or erase operations. With a read operation, memory controller 202 accesses a portion of memory array 204 and retrieves information stored thereto. With a program operation, memory controller 202 selects a portion of memory array 204 and provides bytes of information which memory array 204 stores to a plurality of memory cells. With an erase operation, memory controller 202 selects a block of memory array 204 which is restored to an erased or unprogrammed state.

Memory controller 202, in an example, can be a semiconductor-based processing device with embedded registers, volatile, and/or non-volatile memory. The embedded non-volatile memory can include software instructions (e.g., firmware) executed by the processing device of memory controller 202, which makes use of the embedded registers and/or volatile memory during execution. In addition to, or in place of, the firmware, memory controller 202 can include hardware-based circuits capable of performing tasks similar to tasks encoded by the firmware.

One such task of memory controller 202, as described herein, is wear leveling. In accordance with an embodiment, memory controller 202 can include a wear leveling engine (not shown) implemented in hardware with various circuits in memory controller 202, in the firmware stored on the non-volatile memory, or as a combination of hardware elements and firmware elements. When performing wear leveling, memory controller 202 interacts with state information 206 maintained by memory device 200. State information 206 can include a data structure that retains a state for respective sectors of memory array 204. As shown in FIG. 2, such states can be one of VALID, STALE, or FREE, with VALID indicating the sector includes valid data, STALE indicating the sector includes old data no longer used by the host system, and FREE indicating the sector is in an unprogrammed state.

State information 206, while shown as a separate entity of memory device 200, can stored on a dedicated non-volatile memory of memory device 200, or on a reserved portion of memory array 204. As further shown in FIG. 2, memory controller 202, while performing wear leveling, can issue state queries to state information 206 and receive state responses, corresponding to sectors specified by memory controller 202 (e.g., a target sector and a minimally cycled sector). Based on the state responses, memory controller 202 can perform wear leveling as described above in connection with FIG. 1.

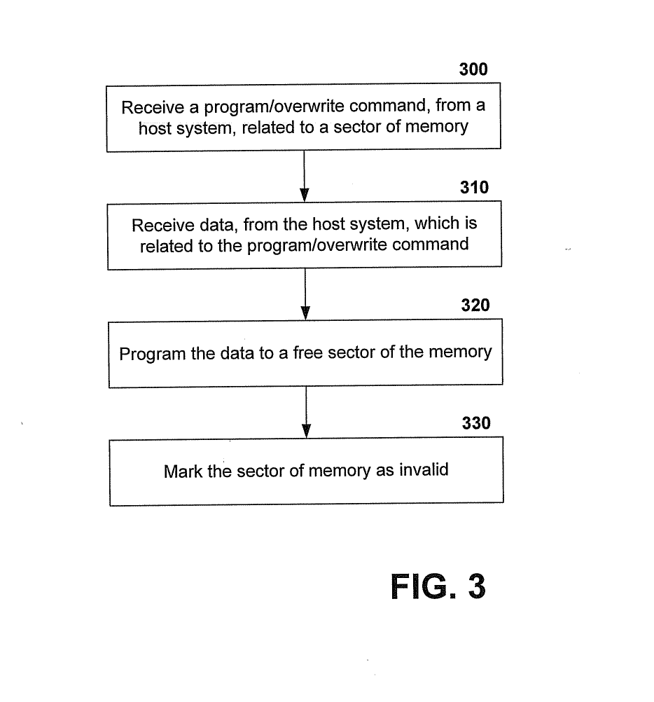

FIG. 3 illustrates a flow diagram of an exemplary, non-limiting embodiment for programming data to a memory device. At 300, a program (overwrite) command, pertaining to a sector of a memory array, is received from a host system. In an example, the program command can specify modified data to be written in place of existing data stored at the sector of the memory array. At 310, data is received from the host system, where the data is related to the program command. At 320, the data received is programmed (e.g., written) to a free sector of the memory array, where the free sector of the memory is different from the sector of the memory array to which the program command relates. At 330, the sector of the memory array to which the program command relates, is marked as invalid (e.g., STALE) in a state information table. In addition, an addressing table can be updated so that addresses received from the host system, which previously indicated the sector of the memory array to which the program command relates, map to the sector to which the data is programmed.

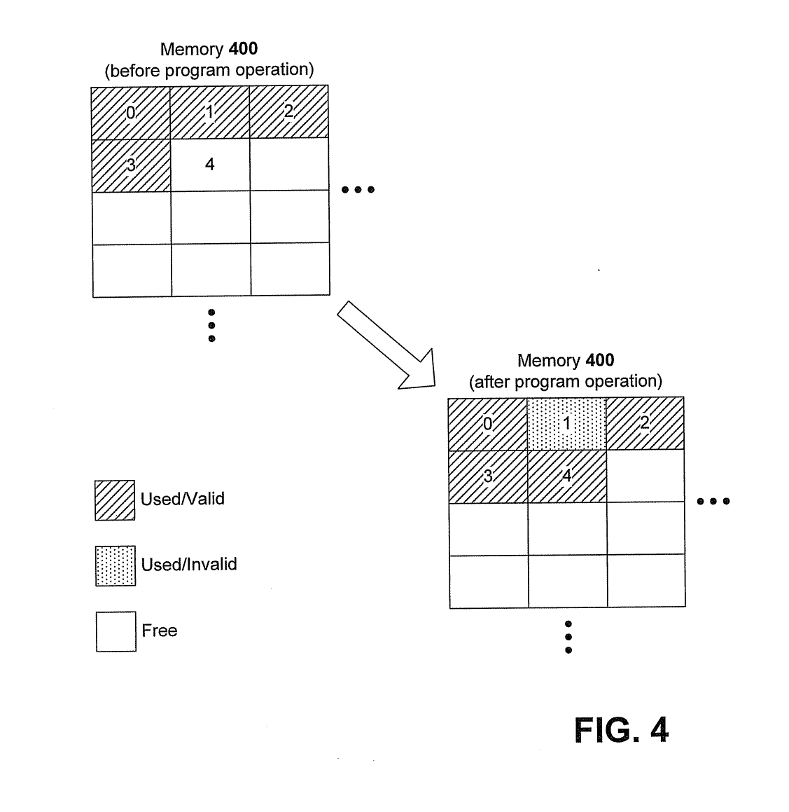

FIG. 4 illustrates a block diagram of an exemplary, non-limiting act of programming data to a memory device. According to an example, FIG. 4 illustrates the embodiment of FIG. 3 described above. As shown in FIG. 4, a portion of a memory 400 is depicted as a series of blocks. Memory 400 is shown prior to a program operation. For instance, blocks 0-3 of memory 400 are used and contain valid data and block 4 remains free. After a program operation to an address mapped to block 1, data received from a host system is programmed to block 4, and block 1 is marked as containing invalid data. The address mappings are also updated such that the address previously mapped to block 1 becomes mapped to block 4 to maintain proper storage services from the perspective of the host system.

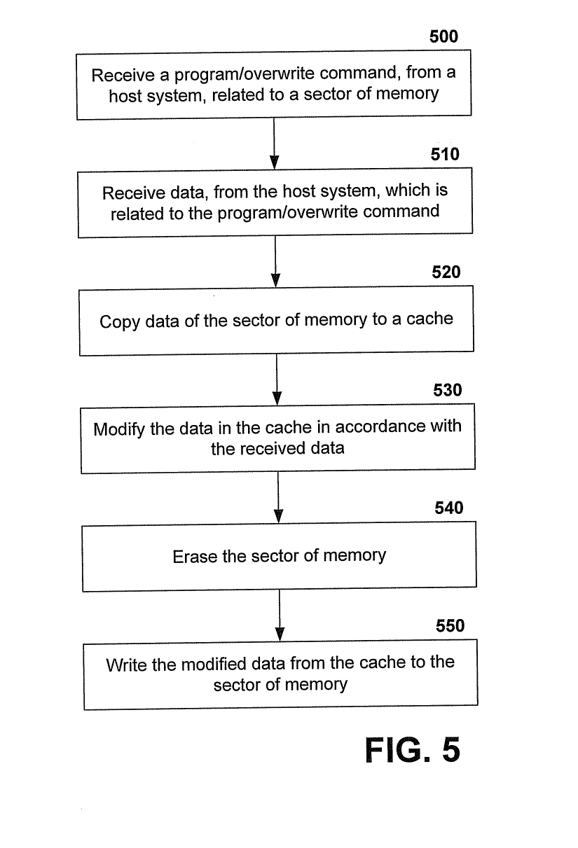

FIG. 5 is a flow diagram of an exemplary, non-limiting embodiment for overwriting data on a memory device. At 500, a program (overwrite) command, pertaining to a sector of a memory array, is received from a host system. At 510, data is received from the host system, where the data is related to the program command. In contrast to the embodiment described above with reference to FIG. 3, the embodiment of FIG. 5 relates to a memory device nearing full capacity such that free blocks are not available for programming of the received data. Accordingly, an overwrite procedure occurs. According to an exemplary overwrite procedure, at 520, data in the sector of memory specified by the program command is copied to a cache. The cache can be an internal portion of memory (e.g., volatile or non-volatile) such as a register, a portion of RAM, etc. In another aspect, the cache can be a reserved or scratch sector of the memory array. At 530, the data in the cache is modified in accordance with the data received in connection with the program command. At 540, the sector of memory specified by the program command is erased. At 550, the modified data from the cache is programmed to the erased sector of memory.

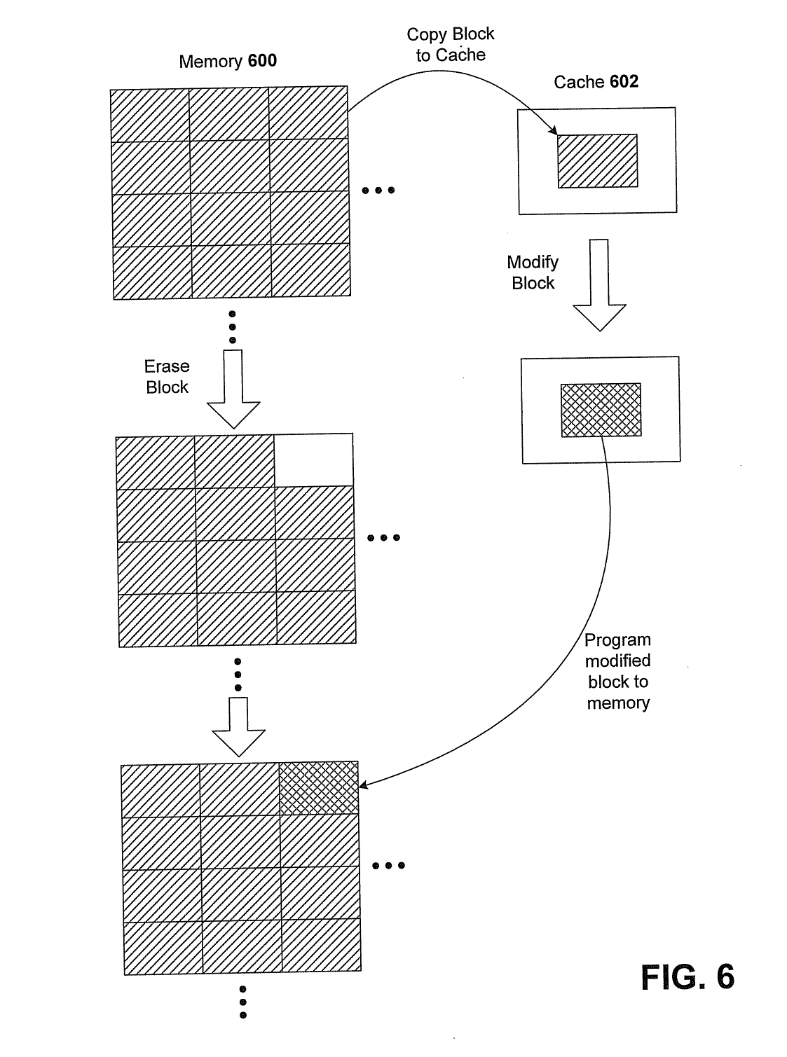

FIG. 6 is a block diagram of an exemplary, non-limiting act of overwriting data on a memory device. According to an example, FIG. 6 illustrates the embodiment of FIG. 5 described above. A portion of a memory 600 is depicted in FIG. 6 and, as shown in the figure, includes a series of used blocks. A block of memory 600 is copied to a cache 602, where it is modified. The block of memory 600 is erased to result in a free or unprogrammed block. The modified block is copied from cache 602 and programmed to the erased sector as shown in FIG. 6.

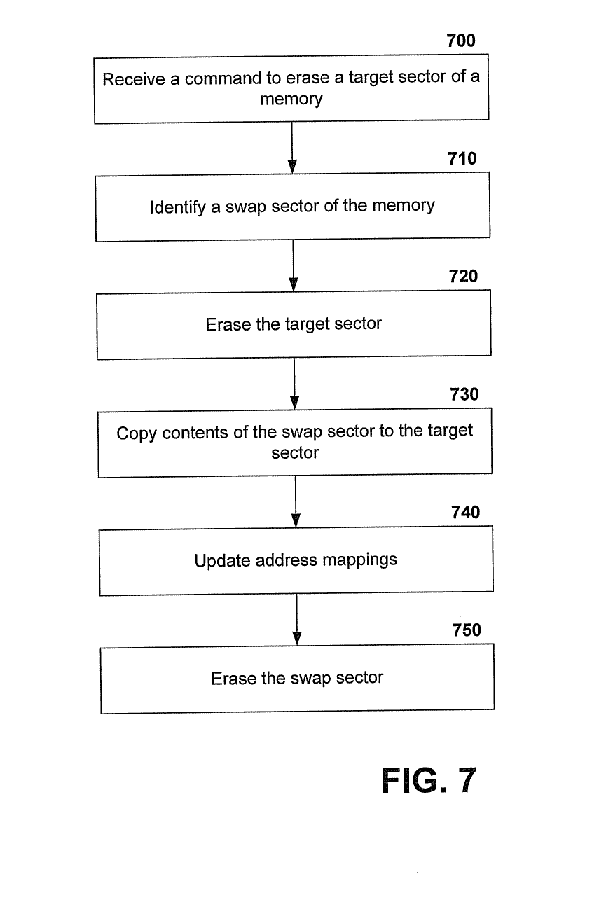

FIG. 7 is a flow diagram illustrating an exemplary, non-limiting embodiment for performing a conventional wear leveling operation. At 700, a command to erase a target sector of a memory is received. As mentioned above, the command can be externally generated (e.g., from a host system) or internally generated (e.g., part of garbage collecting). At 710, a swap sector, of the memory, is identified. At 720, the target sector is erased. At 730, contents of the swap sector are copied to the target sector. At 740, address mappings are updated so that an address previously addressing the swap sector becomes mapped to the target sector to maintain addressability of the copied data. At 750, the swap sector is erased.

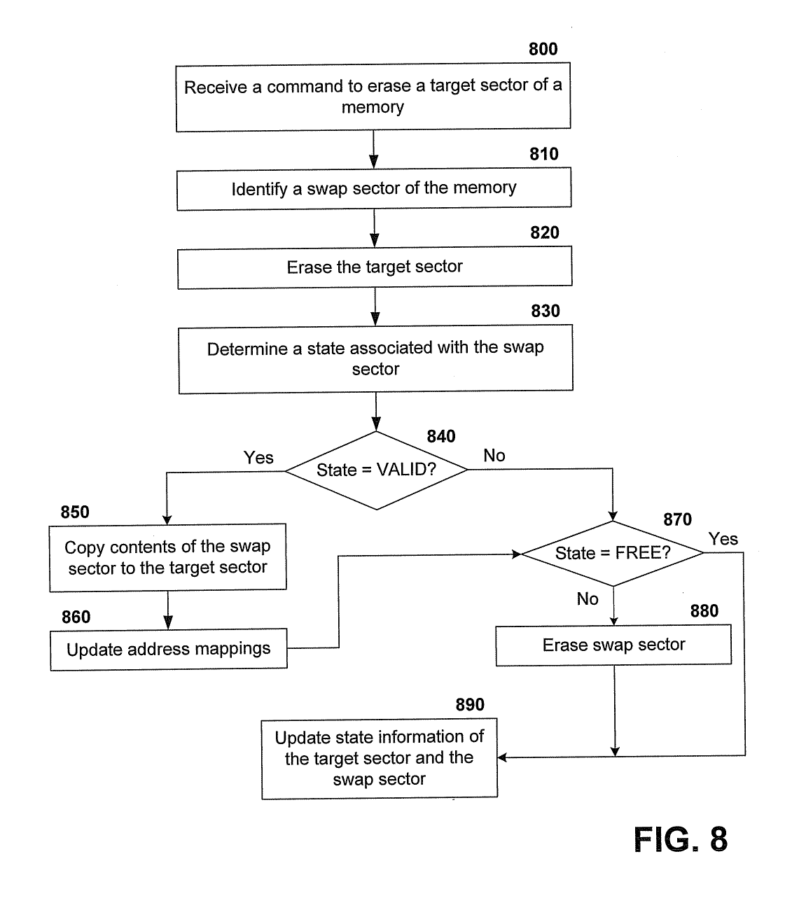

FIG. 8 is a flow diagram illustrating an exemplary, non-limiting embodiment for performing a wear leveling operation in view of state information on sectors. At 800, a command to erase a target sector of a memory is received. At 810, a swap sector of the memory is identified. In an example, identifying a swap sector can include determining a minimally cycled sector (e.g., a sector which has undergone a fewest number of program/erase cycles) of the memory. At 820, the target sector is erased. At 830, a state associated with the swap sector is determined. At 840, a check is made as to whether the state is VALID. If yes, then, at 850, the contents of the swap sector to the target sector. Then, at 860, address mappings are updated to account for the transfer of data from one sector to another. After 860, or if, at 840, the state is not VALID, a second check is performed on the state to determine whether the state is FREE, at 870. If no, then, at 880, the swap sector is erased. However, if, at 870, the state is not FREE, or after erasure at 880, the state information of the target sector and the swap sector are updated at 890. In an example, the state of the target state can be updated to VALID, if the contents of the swap sector were copied, or changed to FREE, if the contents of the swap sector were not copied. In furtherance of this example, the state of the swap sector can be changed to FREE.

A TRIM command, according to an aspect, is a special command issued by a host system to a memory device to indicate sectors of a memory array of the memory device, which no longer contain valid data from the perspective of the host system. By way of example, conventional file systems, when a file is deleted, simply update bookkeeping records to indicate the blocks occupied by the file are free. However, no erasure or overwriting typically occurs. Thus, from the perspective of a memory device, such as a flash memory device, the blocks occupied by the file remain valid and the memory device manages the blocks accordingly (e.g., maintains the blocks during garbage collecting, swaps the blocks during wear leveling, etc.). Thus, the blocks of memory, though of no use to the host system, are maintained by the memory device, which can lead to increases in write amplification and, subsequently, decreases in throughput and increases in wear.

TRIM commands have emerged as a mechanism by which an operating system (or file system) of the host system can indicate blocks of data, stored by the memory device, which are no longer considered to be in use. Thus, the memory device can mark such blocks as invalid and wipe them via erase operations, or ignore indicated portions (e.g., pages) of the blocks during garbage collecting on the blocks. While TRIM commands, and, accordingly, sector states modified by TRIM command have been utilized to support garbage collecting and erase operations of memory devices, such states are not conventionally employed to support wear leveling as in the embodiments described above.

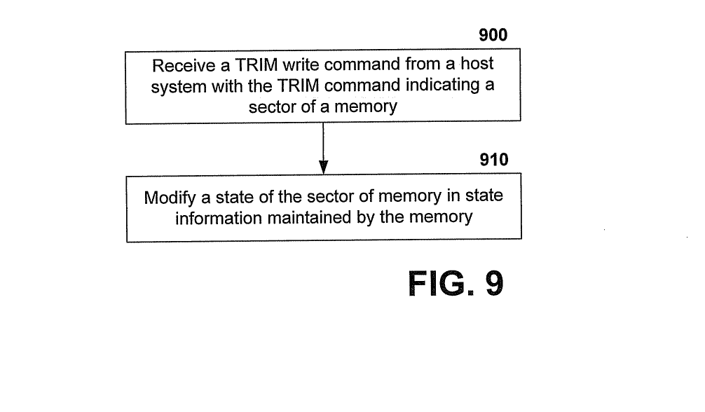

FIG. 9 illustrates a flow diagram of an exemplary, non-limiting embodiment for modifying state information based on a TRIM command. At 900, a TRIM write command is received, from a host system, where the TRIM command indicates a sector of a memory. At 910, a state of the sector of the memory indicated is modified, wherein the state is maintained in state information of the memory. In an example, the TRIM command is utilized to indicate blocks or sectors which are no longer in use. Thus, the state is modified to indicate a STALE state.

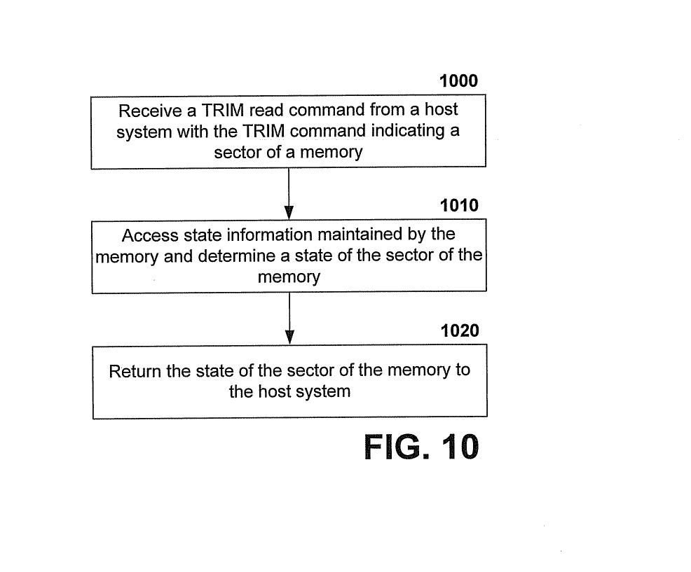

FIG. 10 illustrates a flow diagram of an exemplary, non-limiting embodiment for accessing state information via a TRIM command. At 1000, a TRIM read command is received from the host system, wherein the TRIM read command indicates a sector of a memory. At 1010, state information is accessed and a state associated with the sector of the memory is determined. At 1020, the state of the sector of the memory is returned to the host system.

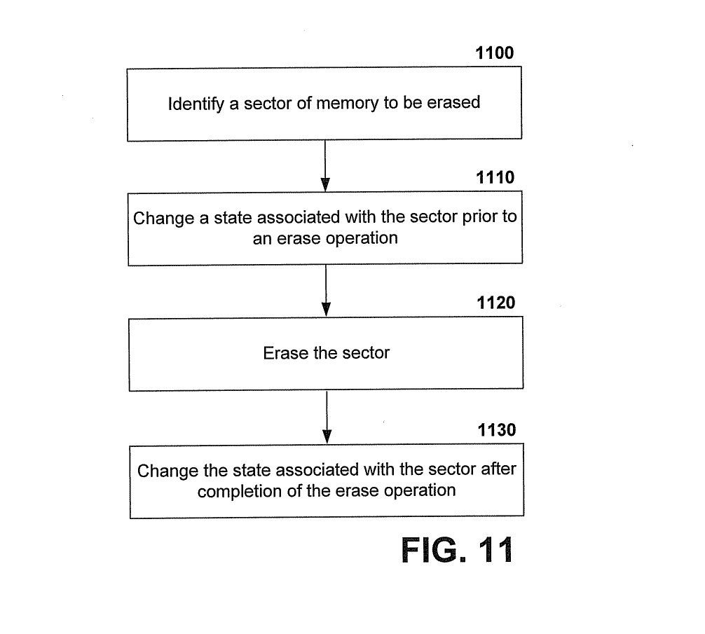

FIG. 11 illustrates a flow diagram of an exemplary, non-limiting embodiment for internally updating state information in accordance with an erase operation. The embodiment of FIG. 11 describes internally generated (e.g., within a memory device) modifications to state information of sectors when the memory device executes embedded operations (e.g., an erase operation). At 1100, a sector of memory is identified which is to be erased during the erase operation. At 1110, a state associated with the sector of memory is changed prior to the erase operation. In an example, the state is changed to an invalid or stale state. The state is changed prior to initiation of the erase to provide resilience against any interruptions (e.g., power failures, etc.) during the erase operations. For instance, by changing the state beforehand, the erase operation, even if interrupted, will resume at a later time since the memory device observes the sector as invalid. However, if the state is not changed beforehand and the erase operation is interrupted, the memory device may continue to manage the sector as valid, leading to lost capacity and decreased throughput via increased write amplification.

At 1120, the sector is erased. At 1130, after completion of the erase operations, the state associated with the sector is changed again. According to an example, the state is changed to indicate a free or unused state.

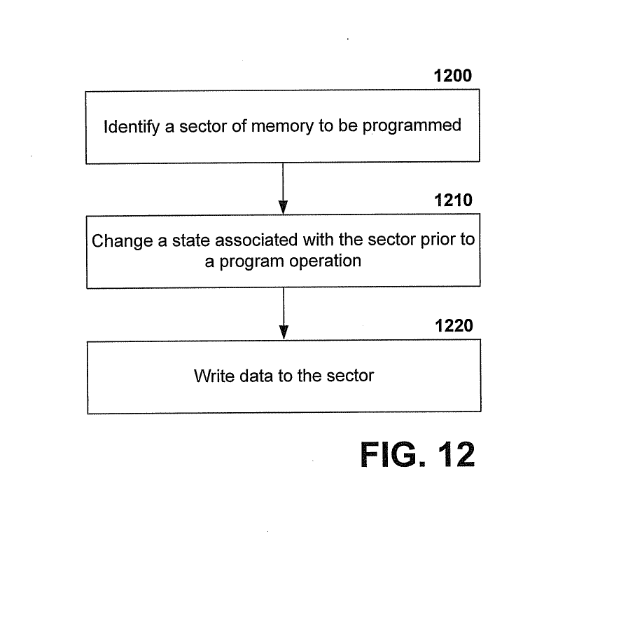

FIG. 12 is a flow diagram of an exemplary, non-limiting embodiment for internally updating state information in accordance with a programming operation. At 1200, a sector of memory to be programmed during the programming operation is identified. At 1210, a state associated with the sector is changed prior to initiation of the programming operation. At 1220, data, to be programmed, is written to the sector.

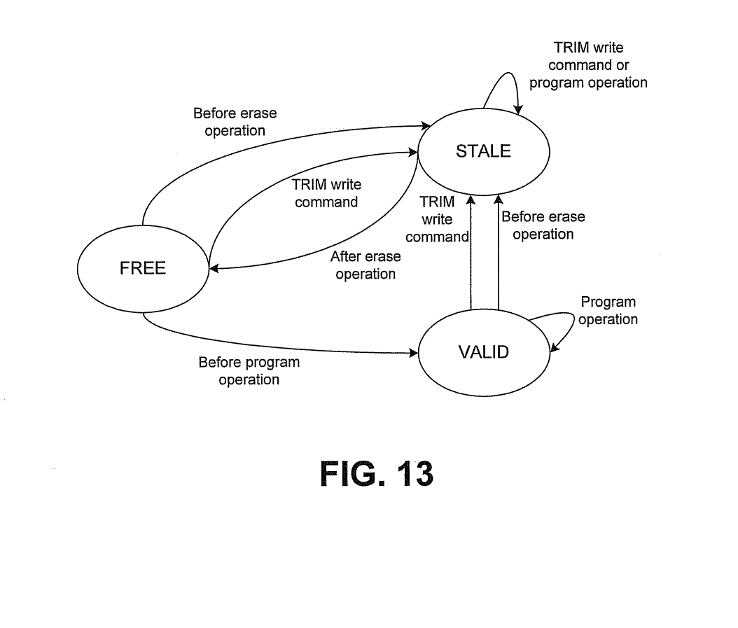

FIG. 13 illustrates a state diagram of sector state information in accordance with one or more aspects of the subject disclosure. As shown in FIG. 13, three states, e.g., FREE, STALE, and VALID, included in the state diagram. A sector of memory, in the FREE state, can transition to the STALE state before an erase operation on the sector of memory, or if a TRIM write command is received for the sector. In addition, while in the FREE state, a sector of memory can transition to the VALID state during a programming operation performed on the sector.

As shown in FIG. 13, for a sector in the STALE state, programming operations performed on the sector (or other sectors) do not alter the state of the sector. In addition, TRIM write command pertaining to the sector, or other sectors, also do not affect the state of sectors in the STALE state. Sectors in the STALE state can transition to the FREE state after completion of an erase operation respectively performed thereto.

For sectors in the VALID state, transitions to the STALE are possible when TRIM write commands respectively associated therewith are received, or prior to erase operations. Programming operations, however, do not alter the state of sectors in the VALID state. In general, read operations do not alter data stored by a memory array and, as such, do not affect states of sectors.

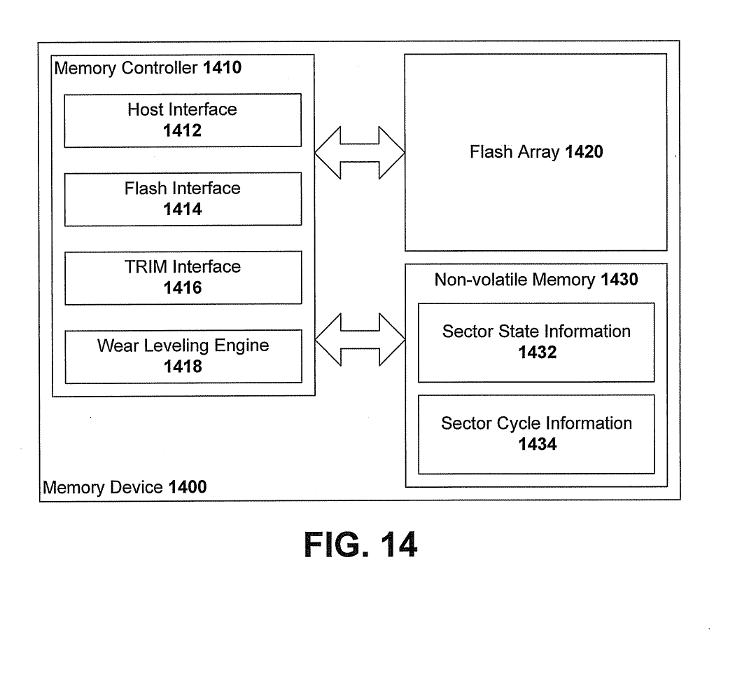

FIG. 14 illustrates a block diagram of an exemplary, non-limiting memory device 1400 in accordance with one or more aspects of the subject disclosure. Memory device 1400, as shown in FIG. 14, can include a memory controller 1410, which can be a semiconductor-based processing device with embedded storage that includes firmware. Memory controller 1410 can be coupled to a bus or circuit board of memory device 1400, which enable memory controller 1410 to communicate with other components included within memory device 1400 as well external components coupled to memory device 1400 via input/output ports (not shown) provided by memory device 1400.

Memory controller 1410 can include a host interface 1412 configured to communicate with a host device via, for example, an input/output port coupled to a system bus of the host device. Host interface 1412, for instance, can interact with a driver program of the host device to receive byte-level access commands (e.g., program, read, erase commands), to receive data to be stored in by a flash array 1420, and to transmit data retrieved from flash array 1420. In addition, memory controller 1410 can include a flash interface 1414 configured to interact with the flash array 1420 via, for instance, a bus internal to memory device 1400. The flash interface 1414, in an aspect, can execute embedded operations (e.g., program, read, erase, etc.) by transmitting appropriate signals to the flash array 1420 to activate portions of the flash array 1420, transmitting data which subsequently programmed to the activated portions, or receiving data which is output from the activated portions.

As shown in FIG. 14, memory device 1400 includes a non-volatile memory 1430 configured to retain sector state information 1432 as described herein. Although shown as being separate from flash array 1420, it is to be appreciated that non-volatile memory 1430 can be a reserved segment of flash array 1420. Similar to flash array 1420, non-volatile memory 1430 can be communicatively coupled to memory controller 1410 via the bus. The bus coupling non-volatile memory 1430 to memory controller 1410 can be a dedicated bus (e.g., separate from the bus coupling flash memory 1420 and memory controller 1410) or a shared bus utilized by multiple components of memory device 1400.

Memory controller 1410 can include a TRIM interface 1416 configured to receive TRIM commands from the host device and modify sector state information 1432 accordingly. In another aspect, TRIM interface 1416 can modify sector state information 1432 as internally directed by memory controller 1410 and/or subsystems of memory controller 1410. As further shown in FIG. 14, memory controller 1410 can include a wear leveling engine 1418 configured to execute wear leveling operations as described above in connection with, for example, the embodiments of FIG. 1 and FIG. 8. According to an aspect, the wear leveling engine 1418 can determine when to initiate a wear leveling operation based on sector cycle information 1434 retained by non-volatile memory 1430. Sector cycle information 1434 specifies respective numbers of program/erase cycles performed on respective sectors of flash array 1420.

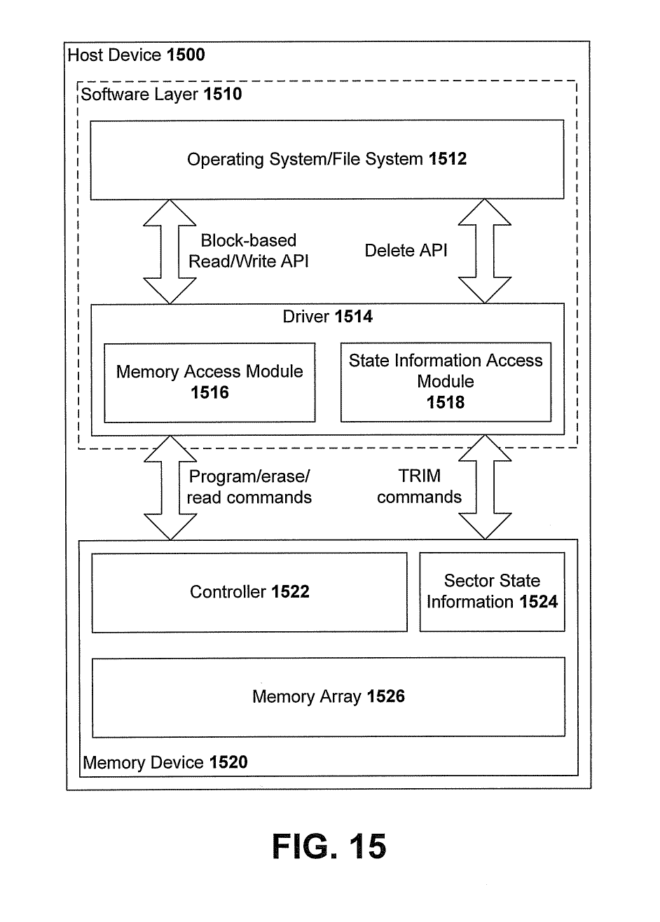

FIG. 15 is a block diagram of an exemplary, non-limiting host system that includes a memory device according to one or more aspects disclosed herein. As shown in FIG. 15, a host device 1500 includes a software layer 1510 that includes an operating system (or file system) 1512 of host device 1500, and a driver 1514 configured to handle low level access to a memory device 1520. Memory device 1520, as shown in FIG. 15, can include a controller 1522, sector state information 1524, and a memory array 1526. In an aspect, memory device 1520 can be substantially similar to memory device 1400 described above with reference to FIG. 14.

According to an example, driver 1514 provides a block-based read/write application program interface (API) and a delete API to operating system (OS) 1512. OS 1512 leverages the APIs to perform file manipulations and other storage related activities. Driver 1514, based on commands received via the exposed APIs, interacts with memory device 1520 in terms of low-level program/erase/read commands or TRIM commands. For instance, driver 1514 includes a memory access module 1516 configured to implement conventional byte access to memory device 1520 (e.g., issue program, erase, and/or read commands) based on block-based read/write commands received from OS 1512. However, as described above, when a file is deleted, a bookkeeping update is performed by OS 1512, which, from the perspective of memory device 1520 does not alter stored data corresponding to the file. Thus, when a file deletion is performed by OS 1512, via the delete API, a state information access module 1518, included in driver 1514, is configured to issue a TRIM command to memory device 1520. As describe above, the TRIM command indicates blocks of memory array 1526 which are considered no longer in use from the perspective of OS 1512. Thus, upon reception of the TRIM command, controller 1522 can modify sector states of sector state information 1524, accordingly, to enable proper management of invalid blocks by memory device 1520.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the systems of the disclosed subject matter, or certain aspects or portions thereof, may take the form of program code (e.g., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device generally includes a processor, a storage medium readable by the processor (including volatile and non-volatile memory and/or storage elements), at least one input device, and at least one output device. In addition, the components may communicate via local and/or remote processes such as in accordance with a signal having one or more data packets (e.g., data from one component interacting with another component in a local system, distributed system, and/or across a network such as the Internet with other systems via the signal).

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, it is known that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the various embodiments.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A memory device, comprising:
a memory array comprising a plurality of memory sectors;
a non-volatile memory configured to retain sector state information, wherein the sector state information that specifies respective usage states for respective sectors of the plurality of memory sectors; and
a memory controller configured to perform a wear leveling operation on two or more sectors of the plurality of memory sectors, the memory array, wherein the wear leveling operation is executed in accordance with respective states of the two or more sectors.

2. The memory device of claim 1, wherein the non-volatile memory is further configured to retain sector cycle information that specifies respective numbers of program/erase cycles performed on respective sectors of the plurality of sectors.

3. The memory device of claim 2, wherein the memory controller is further configured to determine when to initiate the wear leveling operation on the two or more sectors based on respective numbers of program/erase cycles respectively associated with the two or more sectors.

4. The memory device of claim 2, wherein the memory controller is further configured to select at least one of the two or more sectors based on the sector cycle information.

5. The memory device of claim 4, wherein the at least one of the two or more sectors is a minimally cycled sector as indicated in the sector cycle information.

6. The memory device of claim 1, wherein the memory controller is further configured to execute the wear leveling operation in response to an erase operation on the memory array.

7. The memory device of claim 1, wherein the memory controller, to perform the wear leveling operation, is further configured to erase a first sector of the two or more sectors.

8. The memory device of claim 7, wherein the memory controller, to perform the wear leveling operation, is further configured to:
identify a state associated with a second sector of the two or more sectors;
determine whether to copy contents of the second sector to the first sector based on the state identified; and
determine whether to erase the second sector based on the state identified.

9. The memory device of claim 8, wherein the memory controller is further configured to copy the contents of the second sector to the first sector when the state identified is a valid data state.

10. The memory device of claim 9, wherein the memory controller is further configured to update an address mapping such that an address mapped to the second sector becomes mapped to the first sector.

11. The memory device of claim 8, wherein the memory controller is further configured to erase the second sector when the state identified is one of an invalid data state or a valid data state.

12. The memory device of claim 1, wherein the non-volatile memory is a reserved sector of the plurality of sectors.

13. The memory device of claim 1, wherein the usage states included in the sector state information include a free state, a valid data state, and an invalid data state.

14. The memory device of claim 1, wherein the memory controller is further configured to update the sector state information in response to embedded operations performed by the memory controller on the memory array.

15. The memory device of claim 1, wherein the memory controller is further configured to update the sector state information in response to a command received from a host system of the memory device.

16. The memory device of claim 1, wherein the memory array is a flash memory array.

17. A method, comprising:
receiving a command to erase a first sector of a plurality of sectors of a memory array;
identifying a second sector of the plurality of sectors as a swapping sector for a wear leveling operation;
determining a usage state, corresponding the second sector, specified by sector state information;
erasing the first sector;
copying contents of the second sector to the first sector when the usage state of the second sector indicates that the second sector include valid data; and
erasing the second sector when the usage state of the second sector indicates that the second sector includes one of valid data or invalid data.

18. The method of claim 16, further comprising updating the sector state information to indicate the usage state of the second sector is an erased state.

19. A computing device, comprising:
a memory device, comprising:
a memory controller;
a memory array including a plurality of blocks; and
a non-volatile memory configured to retain sector state information; and
a computer-readable storage medium having stored thereon a driver configured to provide storage services to at least one of an operating system or a file system of the computing device and to interface with a memory device embedded with the computing device to implement storage operations in response to requests issued from the at least one of the operating system or the file system,
wherein, in response to an erase operation, generated from at least one of the memory controller or the driver, on a first block of the memory array, the memory controller is configured to initiate a wear leveling operation on the first block and a second block of the memory array accordance with a state of the second block as specified by the sector state information.

20. The computing device of claim 19, wherein
the driver is further configured to transmit a command to memory device when the at least one of the operating system or the file system requests deletion of a file, wherein the command indicates blocks of the memory array associated with the file, and
the memory controller is further configured to update states, in the sector state information, associated with the blocks indicated in the command.
